(19) United States
(12) Patent Application Publication
(10) Pub. No.: US 2021/0317358 A1
(43) Pub. Date: Oct. 14, 2021

(54) METHODS AND COMPOSITIONS FOR TREATING HALITE

(71) Applicant: KEMRIA OYJ, Helsinki (FI)

(72) Inventors: Rick Griffin, Kennesaw, GA (US); Wayne Dickinson, Atlanta, GA (US)

(21) Appl. No.: 17/271,678

(22) PCT Filed: Aug. 30, 2019
(86) PCT No.: PCT/US2019/049021

§ 371 Date: Feb. 26, 2021

Related U.S. Application Data
(60) Provisional application No. 62/725,090, filed on Aug. 30, 2018.

(51) Int. Cl. C09K 8/528; C09K 8/588; E21B 43/20; E21B 37/06

(52) U.S. Cl. CPC C09K 8/528; E21B 37/06; E21B 43/20; C09K 8/588

(57) ABSTRACT

The present embodiments generally relate to methods and compositions for the treatment of halite, such as controlling, preventing, and/or inhibiting halite formation and/or the rate of halite formation, in a fluid in need of treatment, such as fluids used in and/or resulting from oil and gas operations or desalination processes, wherein said treatment comprises the use of one or more crystal modifiers. The one or more crystal modifiers may comprise one or more polymer-based crystal modifiers.

### FIELD OF THE ART

The present disclosure generally relates to methods for controlling halite formation, wherein said methods comprise the use of one or more crystal modifiers, such as one or more polymer-based crystal modifiers; compositions comprising such one or more crystal modifiers; and environments such as oil and gas wells and oilfield brines treated with such crystal modifiers.

### BACKGROUND

The formation and presence of halite can adversely affect a number of industrial processing systems and circuits, such as those used for oil and gas operations as well as desalination processes. For example, halite presents significant challenges in low water cut gas wells as after the brine reaches saturation, halite may begin to precipitate and plug components such as production lines, filters, pumps, and screens. In some instances, a temperature or pressure drop, or water evaporation, may lead to halite formation, particularly in environments comprising a high total dissolved solids content, such as, for example, deepwater fields, shale formations, and gas and gas condensate fields. Moreover, conditions that promote halite formation are often present in systems and apparatuses used in oil recovery processes, such as enhanced oil recovery processes. Further, with particular respect to desalination processes, the limiting factor for purified water recovery is the solubility of the concentrated salts such as sodium chloride (halite).

Halite formation can result in adverse effects, such as, for example, reduced production rates; flow restrictions which may include blockages and/or full plugging of pipelines, wellbores, and/or formations; under-deposit corrosion; increased water usage, and increased cleaning costs and equipment damage and/or failure in a number of industrial systems and circuits. These challenges ultimately cause losses in production, increased operating costs, and increased capital equipment expenditures. Generally, copious amounts of water must be injected to remove the halite, and, in many locations, available water for such an operation is in short supply and/or costly to transport to the production site. As such, use of water to treat halite is often not a cost-effective proposition. Development of more efficient and cost-effective methods and compositions for halite treatment are therefore of great interest to a number of industries.

### BRIEF SUMMARY

The present disclosure generally relates to a method for treating halite, wherein said method comprises adding or introducing one or more crystal modifiers to a fluid in need of treatment. In some embodiments, said one or more crystal modifiers may comprise polymer-based crystal modifiers. In some embodiments, said one or more crystal modifiers may comprise a copolymer of sulfonated monomers and carboxylic acid monomers, wherein said copolymer is amine-neutralized. In some embodiments, said one or more crystal modifiers may comprise one or more of the following: vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate. In some embodiments, said one or more crystal modifiers may comprise one or more of the following: acrylic acid, methacrylic acid, crotonic acid, itaconic acid, fumaric acid, and/or maleic acid. In some embodiments, said one or more crystal modifiers may comprise one or more of the following: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine. In some embodiments, said one or more crystal modifiers may comprise one or more of the following: mono-, di-, and tri-ethanolamine In some embodiments, said one or more crystal modifiers may comprise one or more of the following: N,N-dimethylethanolamine (DMEA), N-methyldiethanolamine (MDEA), and/or N-methylethanolamine (NMEA). In some embodiments, said one or more crystal modifiers may comprise aminoethylethanolamine. In some embodiments, said one or more crystal modifiers may comprise N-methyldiethanolamine. In some embodiments, said one or more crystal modifiers comprise N-methylethanolamine. In some embodiments, said one or more crystal modifiers may comprise one or more ethylenically unsaturated diacid components which comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride. In some embodiments, said one or more crystal modifiers comprise one or more polymer-based crystal modifiers comprising an ethanolamine salt of a copolymer of sodium allyl sulphonate and maleic anhydride. In some embodiments, said one or more crystal modifiers comprise one or more polymer-based crystal modifiers and one or more ferrocyanide salt-based crystal modifiers. In some embodiments, said one or more crystal modifiers may comprise one or more polymer-based crystal modifiers comprising an ethanolamine salt of a copolymer of sodium allyl sulphonate and maleic anhydride and one or more ferrocyanide salt-based crystal modifiers, and, optionally, said methods comprising use of said one or more polymer-based crystal modifiers and said one or more ferrocyanide-salt based crystal modifiers may result in synergetic effects.

In some embodiments, said fluid in need of treatment may comprise a fluid resulting from any part of processes related to oil or gas production, extraction, and/or recovery. In some embodiments, said fluid in need of treatment may comprise a circulating fluid. In some embodiments, said fluid in need of treatment may comprise produced water. In some embodiments, said fluid in need of treatment may comprise sodium and chloride that precipitate as halite.

In some embodiments, treatment of said fluid with said one or more crystal modifiers may result in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of halite formation as compared to a method which did not comprise the use of said one or more crystal modifiers. In some embodiments, treatment of said fluid with said one or more crystal modifiers may result in the percent transmittance of a fluid treated according to any of the foregoing methods decreasing by 0.5% or less, 1.0% or less, 2.0% or less, 3.0% or less, 4.0% or less, 5.0% or less, 6.0% or less, 7.0% or less, 8.0% or less, 9.0% or less, 10.0% or less, 12.5% or less, 15.0% or less, 17.5% or less, 20% or less, 25% or less, 30% or less, 35% or less, 40% or less, 45% or less, 50% or less, 55% or less, 60% or less, or 60% or more as compared to its initial value prior to treatment. In some embodiments, treatment of said fluid with said one or more crystal modifiers may result in a decrease in the amount of water that is used to treat halite as compared to a method which does not comprise the use of said one or more crystal modifiers, optionally wherein the decrease in amount of water that is used to treat halite may be elimination of the use of any amount of water to treat halite.

Furthermore, the present disclosure generally relates to a composition suitable for use in the treatment of halite, wherein said composition comprises one or more crystal modifiers and optionally a fluid in need of treatment. In some embodiments, said one or more crystal modifiers may comprise polymer-based crystal modifiers. In some embodiments, said one or more crystal modifiers may comprise a copolymer of sulfonated monomers and carboxylic acid monomers, wherein said copolymer is amine-neutralized. In some embodiments, said one or more crystal modifiers may comprise one or more of the following: vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate. In some embodiments, said one or more crystal modifiers may comprise one or more of the following: acrylic acid, methacrylic acid, crotonic acid, itaconic acid, fumaric acid, and/or maleic acid. In some embodiments, said one or more crystal modifiers may comprise one or more of the following: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine. In some embodiments, said one or more crystal modifiers may comprise one or more of the following: mono-, di-, and tri-ethanolamine. In some embodiments, said one or more crystal modifiers may comprise one or more of the following: N,N-dimethylethanolamine (DMEA), N-methyldiethanolamine (MDEA), and/or N-methylethanolamine (NMEA). In some embodiments, said one or more crystal modifiers may comprise aminoethylethanolamine. In some embodiments, said one or more crystal modifiers may comprise N-methyldiethanolamine. In some embodiments, said one or more crystal modifiers comprise N-methylethanolamine. In some embodiments, said one or more crystal modifiers may comprise one or more ethylenically unsaturated diacid components which comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride. In some embodiments, said one or more crystal modifiers comprise one or more polymer-based crystal modifiers comprising an ethanolamine salt of a copolymer of sodium allyl sulphonate and maleic anhydride. In some embodiments, said one or more crystal modifiers comprise one or more polymer-based crystal modifiers and one or more ferrocyanide salt-based crystal modifiers. In some embodiments, said one or more crystal modifiers comprise one or more polymer-based crystal modifiers comprising an ethanolamine salt of a copolymer of sodium allyl sulphonate and maleic anhydride and one or more ferrocyanide salt-based crystal modifiers.

BRIEF DESCRIPTION OF THE SEVERAL VIEWS OF THE DRAWING

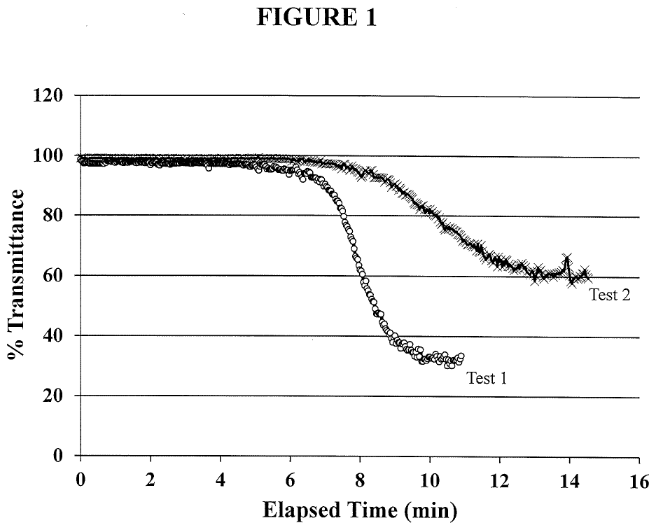

FIG. 1 illustrates halite formation control runs (“Test 1” and “Test 2”) that were performed in accordance with Example 1.

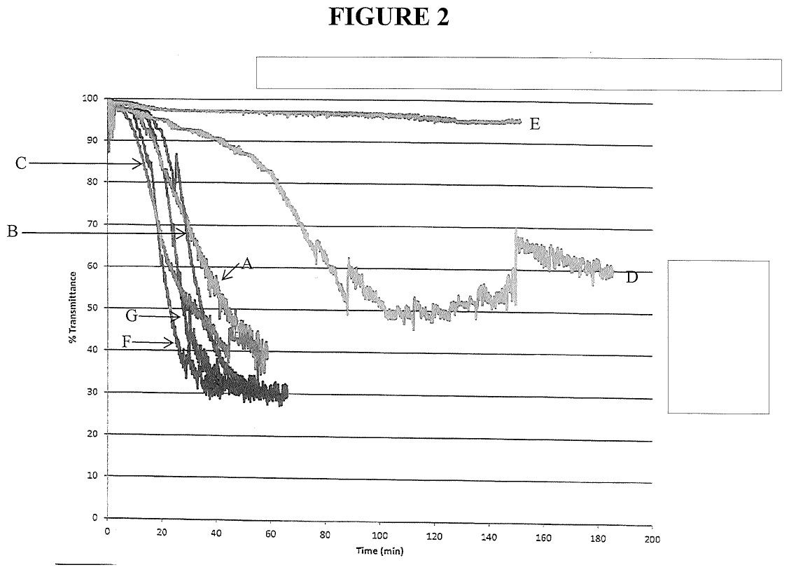

FIG. 2 illustrates inhibition of halite formation that resulted from treatments comprising different doses of a polymer-based crystal modifier, wherein runs comprising doses of 20 ppm (“A”), 40 ppm (“B”), 60 ppm (“C”), 80 ppm (“D”), and 100 ppm (“E”), and two blank runs (“F” and “G”) were performed in accordance with Example 1.

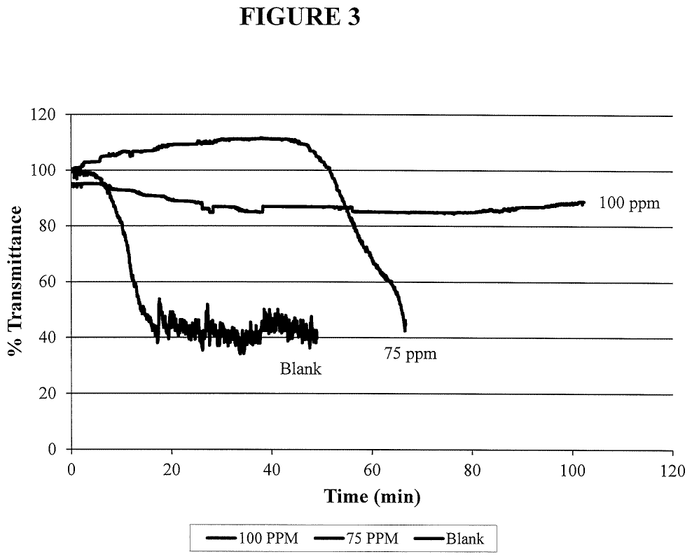

FIG. 3 illustrates inhibition of halite formation that resulted from treatments comprising two different doses (75 ppm and 100 ppm) of a polymer-based crystal modifier at a temperature of 60° C., in accordance with Example 1.

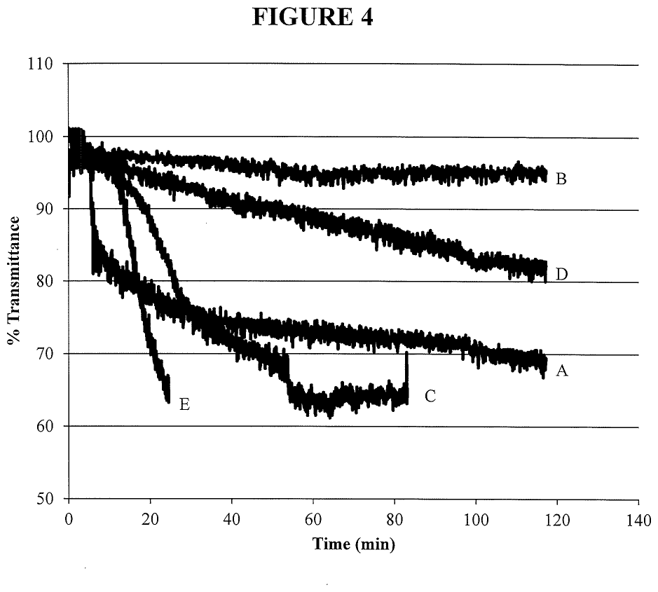

FIG. 4 illustrates inhibition of halite formation that resulted from treatments comprising either a polymer-based crystal modifier, or a ferrocyanide salt-based crystal modifier, wherein runs comprising doses of 10 ppm ferrocyanide salt-based crystal modifier (“A”), 20 ppm ferrocyanide salt-based crystal modifier (“B”), 10 ppm polymer-based crystal modifier (“C”), 20 ppm polymer-based crystal modifier (“D”), and a blank run (“E”) were performed in accordance with Example 2.

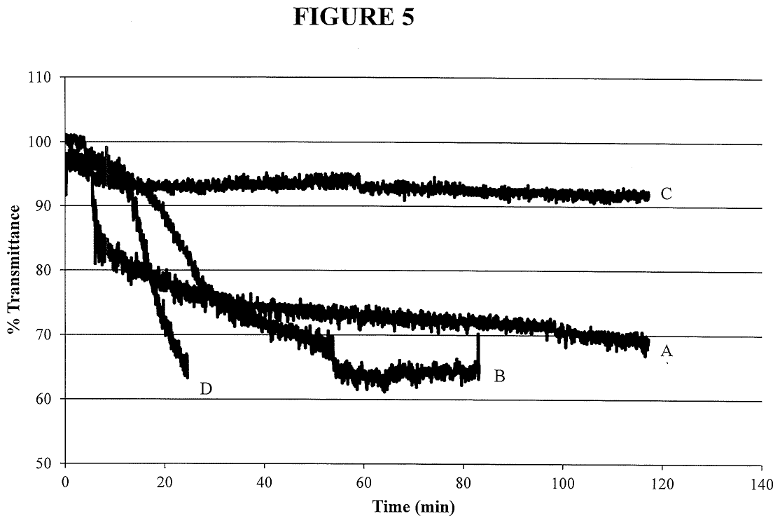

FIG. 5 illustrates synergistic inhibition of halite formation that resulted from treatments comprising a combination of a ferrocyanide salt-based crystal modifier and a polymer-based crystal modifier, wherein runs comprising doses of 10 ppm ferrocyanide salt-based crystal modifier alone (“A”), 10 ppm polymer-based crystal modifier alone (“B”), a combination of 5 ppm ferrocyanide salt-based crystal modifier and 5 ppm polymer-based crystal modifier (“C”), and a blank run (“D”) were performed in accordance with Example 3.

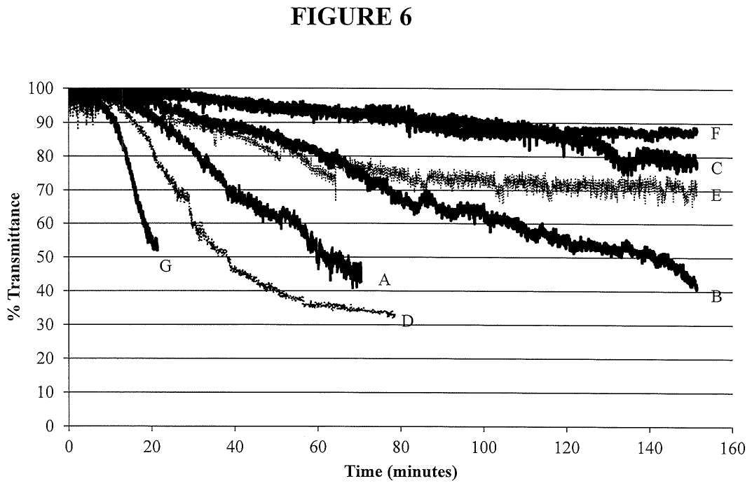

FIG. 6 illustrates inhibition of halite formation that resulted from treatments comprising either thermally treated or untreated polymer-based crystal modifier, wherein runs comprising 20 ppm, 50 ppm, and 100 ppm untreated polymer-based crystal modifier (“A”, “B”, and “C”, respectively); 20 ppm, 50 ppm, and 100 ppm treated polymer-based crystal modifier (“D”, “E”, and “F”, respectively); and a blank run (“G”) were perfoimed in accordance with Example 4.

### DETAILED DESCRIPTION

### Definitions

As used herein the singular forms “a”, “and”, and “the” include plural referents unless the context clearly dictates otherwise. All technical and scientific terms used herein have the same meaning as commonly understood to one of ordinary skill in the art to which this invention belongs unless clearly indicated otherwise.

As used herein, the term “enhanced oil recovery” or “EOR” (sometimes also known as improved oil recovery (“TOR”) or tertiary mineral oil production) generally refers to techniques for increasing the amount of unrefined petroleum (for example, crude oil) that may be extracted from an oil reservoir, such as an oil field. Examples of EOR techniques include, for example, miscible gas injection (e.g., carbon dioxide flooding), chemical injection, which is sometimes referred to as chemical enhanced oil recovery (“CEOR”), and which includes, for example, polymer flooding, alkaline flooding, surfactant flooding, micellar polymer flooding, conformance control operations, as well as combinations thereof such as alkaline-polymer flooding or alkaline-surfactant-polymer flooding, microbial injection, and thermal recovery (e.g., cyclic steam, steam flooding, or fire flooding). In some embodiments, the EOR operation may include a polymer (“P”) flooding operation, an alkaline-polymer (“AP”) flooding operation, a surfactant-polymer (“SP”) flooding operation, an alkaline-surfactant-polymer (“ASP”) flooding operation, a conformance control operation, or any combination thereof.

As used herein, the terms “polymer flood” or “polymer flooding” generally refer to a chemical enhanced EOR technique that typically involves injecting an aqueous fluid that is viscosified with one or more water-soluble polymers through injection boreholes into an oil reservoir to mobilize oil left behind after primary and/or secondary recovery. As a general result of the injection of one or more polymers, the oil may be forced in the direction of the production borehole, and the oil may be produced through the production borehole. Details of examples of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”, which is herein incorporated by reference in its entirety. One or more surfactants may be injected (or formed in situ) as part of the EOR technique. Surfactants may function to reduce the interfacial tension between the oil and water, which may reduce capillary pressure and improve mobilization of oil. Surfactants may be injected with polymers (e.g., a surfactant-polymer (SP) flood), or formed in-situ (e.g., an alkaline-polymer (AP) flood), or a combination thereof (e.g., an alkaline-surfactant-polymer (ASP) flood). As used herein, the terms “polymer flood” and “polymer flooding” encompass all of these EOR techniques.

As used herein, the term “desalination” generally refers a process for removing salts (such as halites) from saline water (such as seawater). As is well known in the art various technologies may be used in such processes including the application of thermal energy to distill the water, vapor compression distillation, reverse osmosis, freeze-thaw, and electrodialysis.

As used herein, the term “monomer” generally refers to nonionic monomers, anionic monomers, cationic monomers, zwitterionic monomers, betaine monomers, and amphoteric ion pair monomers.

As used herein, the terms “polymer,” “polymers,” “polymeric,” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, e.g., polymerizing, a particular monomer. Unless otherwise specified, a polymer may also comprise a “copolymer” that may comprise two or more different recurring units that may be formed by, e.g., copolymerizing, two or more different monomers, and/or by chemically modifying one or more recurring units of a precursor polymer. Unless otherwise specified, a polymer or copolymer may also comprise a “terpolymer” that may comprise polymers that may comprise three or more different recurring units. The term “polymer” as used herein is intended to include both the acid form of the polymer as well as its various salts. Polymers may be amphoteric in nature, i.e., containing both anionic and cationic substituents, although not necessarily in the same proportions.

As used herein the term “nonionic monomer” generally refers to a monomer that possesses a neutral charge. Nonionic monomers may comprise but are not limited to comprising monomers selected from the group consisting of acrylamide (“AMD”), methacrylamido, vinyl, allyl, ethyl, and the like, all of which may be substituted with a side chain selected from, for example, an alkyl, arylalkyl, dialkyl, ethoxyl, and/or hydrophobic group. In some embodiments, a nonionic monomer may comprise AMD. In some embodiments, nonionic monomers may comprise but are not limited to comprising vinyl amide (e.g., acrylamide, methacrylamide, N-methylacrylamide, N,N-dimethylacrylamide), acryloylmorpholine, acrylate, maleic anhydride, N-vinylpyrrolidone, vinyl acetate, N-vinyl formamide and their derivatives, such as hydroxyethyl (methyl)acrylate CH2=CR—COO—CH2CH2OH (I) and CH2=CR—CO—N(Z1)(Z2) (2) N-substituted (methyl)acrylamide (II). R═H or Me; Z1=5-15C alkyl; 1-3 C alkyl substituted by 1-3 phenyl, phenyl or 6-12C cycloalkyl (both optionally substituted) and Z2=H; or Z1 and Z2 are each 3-10C alkyl; (II) is N-tert. hexyl, tert. octyl, methylundecyl, cyclohexyl, benzyl, diphenylmethyl or triphenyl acrylamide. Nonionic monomers further may include dimethylaminoethylacrylate (“DMAEMA”), dimethylaminoethyl methacrylate (“DMAEM”), N-isopropylacrylamide and N-vinyl formamide. Nonionic monomers can be combined, for example to form a terpolymer of acrylamide, N-vinyl formamide, and acrylic acid.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

Examples of anionic monomers which may be used herein include but are not limited to those comprising acrylic, methacrylic, maleic monomers and the like, calcium diacrylate, and/or any monomer substituted with a carboxylic acid group or salt thereof In some embodiments, these anionic monomers may be substituted with a carboxylic acid group, and include, for example, acrylic acid, and methacrylic acid. In some embodiments, an anionic monomer which may be used herein may be a (meth)acrylamide monomer wherein the amide group has been hydrolyzed to a carboxyl group. Said monomer may be a derivative or salt of a monomer according to the embodiments. Additional examples of anionic monomers comprise but are not limited to those comprising sulfonic acids or a sulfonic acid group, or both. In some embodiments, the anionic monomers which may be used herein may comprise a sulfonic function that may comprise, for example, acrylamide tertiary butyl sulfonic acid (also known as 2-acrylamido-2-methylpropane sulfonic acid or N-t-butyl acrylamide sulfonic acid) (“ATBS”). In some embodiments, anionic monomers may comprise organic acids. In some embodiments, anionic monomers may comprise acrylic acid, methacrylic acid, maleic acid, itaconic acid, acrylamido methylpropane sulfonic acid, vinylphosphonic acid, styrene sulfonic acid and their salts such as sodium, ammonium and potassium. Anionic monomers can be combined, for example, to form a terpolymer of acrylamide, acrylic acid and 2-acrylamido-2-methylpropane sulfonic acid.

As used herein, the teiiii “cationic monomer” generally refers to a monomer that possesses a positive charge. Examples of cationic monomers may comprise but are not limited to those comprising acryloyloxy ethyl trimethyl ammonium chloride (“AETAC”), methacryloyloxyethyltrimethylammonium chloride, methacrylamidopropyltrimethylammonium chloride (“MAPTAC”), acrylamidopropyltrimethylammonium chloride, methacryloyloxyethyldimethylammonium sulfate, dimethylaminoethyl acrylate, dimethylaminopropylmethacrylamide, Q6, Q6o 4, and/or diallyldimethylammonium chloride (“DADMAC”).

Said cationic monomers may also comprise but are not limited to comprising dialkylaminoalkyl acrylates and methacrylates and their quaternary or acid salts, including, but not limited to, dimethylaminoethyl acrylate methyl chloride quaternary salt (“DMAEA.MCQ”), dimethylaminoethyl acrylate methyl sulfate quaternary salt (“DMAEM.MCQ”), dimethyaminoethyl acrylate benzyl chloride quaternary salt (“DMAEA.BCQ”), dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate and diallyldialkylammonium halides such as diallyldiethylammonium chloride and diallyldimethyl ammonium chloride. Alkyl groups may generally but are not limited to those comprising C₁₋₈ alkyl groups. In some embodiments, cationic monomers may comprise quaternary ammonium or acid salts of vinyl amide, vinyl carboxylic acid, methacrylate and their derivatives. Cationic monomers may comprise but are not limited to comprising monomers selected from the group consisting of dimethylaminoethylacrylate methyl chloride quaternary salt, dimethylaminoethylmethacrylate methyl chloride quaternary salt, and diallyldimethyl ammonium chloride. Cationic monomers can be combined, for example, to form a terpolymer of dimethylaminoethylmethacrylate methyl chloride quaternary salt, and diallyldimethyl ammonium chloride and acrylamide.

The term “water-soluble polymer” generally refers to any polymer that may dissolve, disperse, or swell in water. Said polymers may modify the physical properties of aqueous systems undergoing gellation, thickening, viscosification, or emulsification/stabilization. Said polymers may perform a variety of functions, including but not limited to use as dispersing and suspending agents, stabilizers, thickeners (“thickening polymer” and/or “thickening agent”), viscosifiers (“visosifying polymer” and/or “visosifying agent”), gellants, flocculants and coagulants, film-formers, humectants, binders, and lubricants.

In the context of polymer flooding, a water-soluble polymer may include, but not be limited to including, one or more high molecular weight polyacrylamide and/or copolymers of acrylamide and further monomers, for example, vinylsulfonic acid or acrylic acid. Polyacrylamide may be partly hydrolyzed polyacrylamide (“HPAM”), in which some of the acrylamide units have been hydrolyzed to acrylic acid. In some embodiments, a water soluble polymer may comprise a high molecular weight anionic polyacrylamide based polymer. Naturally occurring polymers may also be used, for example, xanthan or polyglycosylglucan. Naturally occurring polymers may be used in their natural form and/or in a modified form.

As used herein, the terms “polyacrylamide” or “PAM” generally refer to polymers and co-polymers comprising acrylamide moieties, and the tern's encompass any polymers or copolymers comprising acrylamide moieties, e.g., one or more acrylamide (co)polymers. Furthermore, PAMs may comprise any of the polymers or copolymers discussed herein. Additionally, the PAMs described herein, e.g., one or more acrylamide (co)polymers, may be provided in one of various forms, including, for example, dry (powder) form (e.g., DPAM), water-in-oil emulsion (inverse emulsion), suspension, dispersion, or partly hydrolyzed (e.g., HPAM, in which some of the acrylamide units have been hydrolyzed to acrylic acid). In some embodiments, PAMs, e.g., one or more acrylamide (co)polymers, may be used for polymer flooding. In some embodiments, PAMS, e.g., one or more acrylamide (co)polymers, may be used in any EOR technique.

As used herein, the term “produced water” generally refers to any aqueous fluids produced during any type of industrial process, e.g., an oil or gas extraction or recovery process, e.g., a mining process, e.g., a coal transport process, or any portion thereof, such as but not limited to any enhanced oil recovery process or any portion thereof. Typically the produced water may be obtained during an industrial process involving the use of water, and, in some instances, the use of one or more water soluble polymers.

According to some embodiments, the produced water may be formed during any part of a process related to polymer flooding and may comprise any components and/or chemicals related to any part of said polymer flooding. This may be referred to as “polymer flooded produced water” or “polymer flooding produced water”, and the term produced water is to be understood to encompass any type of polymer flooded produced water or polymer flooding produced water.

As used herein, the terms “scale” and “mineral scale” generally refer to the accumulation of unwanted material on solid surfaces, and particularly includes environments wherein such deposition is to the detriment of the functioning, stability and/or physical integrity of the solid surface comprising such deposition such as an apparatus on which scale forms.

As used herein, the term “crystal modifier” generally refers chemical compounds, e.g., polymers, or compositions containing such compounds, that may be added to a fluid, to interfere with nucleation, growth, and/or agglomeration of particles that may form crystals, e.g., halite, and thereby control, reduce, inhibit, or prevent the formation, deposition, and/or adherence of crystal deposits, e.g., halite deposits, on substrate surfaces in contact with crystal-forming fluids. The crystal modifiers may control, reduce, inhibit, or prevent the formation of crystals (for example, the total amount and/or rate of formation of crystals such as halite) in a particular system as compared to an equivalent system that does not contain the added crystal modifier. In some embodiments, a crystal modifier is added to a fluid in which a crystal may form, such as, for example, a fluid comprising sodium and chloride, which may be referred to as a fluid in need of treatment. In some embodiments, a crystal modifier may comprise a polymer-based crystal modifier, i.e., a crystal modifier comprising one or more polymers. In some embodiments, a crystal modifier may comprise a copolymer of sulfonated monomers and carboxylic acid monomers, wherein said copolymer may be amine-neutralized. In some embodiments, said copolymer of sulfonated monomers and carboxylic acid monomers which may be amine-neutralized may comprise one or more of the following: vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate. In some embodiments, said copolymer of sulfonated monomers and carboxylic acid monomers which may be amine-neutralized may comprise one or more of the following: acrylic acid, methacrylic acid, crotonic acid, itaconic acid, fumaric acid, and/or maleic acid. In some embodiments, a copolymer of sulfonated monomers and carboxylic acid monomers which may be amine neutralized may comprise any one or more of the following amine moieties: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine. In some embodiments, a copolymer of sulfonated monomers and carboxylic acid monomers which may be amine neutralized may comprise any one or more of the following amine moieties: mono-, di-, and tri-ethanolamine. In some embodiments, a copolymer of sulfonated monomers and carboxylic acid monomers which may be amine neutralized may comprise any one or more of the following amine moieties: N,N-dimethylethanolamine (DMEA), N-methyldiethanolamine (MDEA), and/or N-methylethanolamine (NMEA). In some embodiments, a copolymer of sulfonated monomers and carboxylic acid monomers which may be amine neutralized may comprise aminoethylethanolamine. In some embodiments, a copolymer of sulfonated monomers and carboxylic acid monomers which may be amine neutralized may comprise N-methyldiethanolamine. In some embodiments, a copolymer of sulfonated monomers and carboxylic acid monomers which may be amine neutralized may comprise N-methylethanolamine. Moreover, in some embodiments, a copolymer of sulfonated monomers and carboxylic acid monomers which may be amine neutralized may comprise one or more ethylenically unsaturated diacid components which may comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride. In general, the ethylenically unsaturated dicarboxylic acids and anhydrides may comprise 4 to 8 carbon atoms, however, in some embodiments, they may comprise anywhere from 4 to 36 carbon atoms. In some embodiments, a crystal modifier may comprise an ethanolamine salt of a copolymer of sodium allyl sulphonate and maleic anhydride. In some embodiments, a polymer-based crystal modifier may comprise an ethanolamine salt of a copolymer of sodium allyl sulphonate and maleic anhydride. In some embodiments, a crystal modifier may comprise a ferrocyanide salt-based crystal modifier, such as, for example, a [Fe(CN)₆]⁴⁻ salt-based crystal modifier.

As used herein, the term “halite” generally refers to the mineral and/or crystalline form of sodium chloride. Halite generally forms as crystals of sodium chloride. In some instances, halite may be referred to as “halite scale”, and the term “halite” is to be understood to encompass “halite scale”. Halite may accumulate on solid surfaces, and its deposition may be a detriment for the functioning of the apparatus and/or process in which the halite forms. In some embodiments, one or more crystal modifiers may be used to treat halite. In some embodiments, a polymer-based crystal modifier may be used to treat halite. In some embodiments, a crystal modifier comprising a copolymer of sulfonated monomers and carboxylic acid monomers, wherein said copolymer may be amine-neutralized, may be used to treat halite. Said crystal modifier may comprise any one or more of the sulfonated monomers, carboxylic acid monomers, and amine moieties discussed herein. In some embodiments, a crystal modifier and/or a polymer-based crystal modifier comprising an ethanolamine salt of a copolymer of sodium allyl sulphonate and maleic anhydride may be used to treat halite. In some embodiments, a combination of a polymer-based crystal modifier and a ferrocyanide salt-based crystal modifier may be used to treat halite, and, in some instances, treatment with such a composition may be synergistic in nature. In some embodiments, methods comprising the use of one or more crystal modifiers, e.g., one or more polymer-based crystal modifiers, may be used to treat, reduce, control, prevent, and/or inhibit the formation of halite, such as halite that may form during one or more processes, e.g., in aqueous systems such as boiler water, cooling water, seawater (e.g., in oil platform applications), brackish water, oilfield water, mining water, water at various stages of desalination processes, coal processing water, and industrial treatment plant water. In some embodiments, methods comprising the use of one or more crystal modifiers, e.g., one or more polymer-based crystal modifiers, may be used to treat, reduce, control, prevent, and/or inhibit the formation of halite in produced water. In some embodiments, halite that may form as a result of processes related to oil and/or gas exploration and production may be treated with one or more crystal modifiers, e.g., one or more polymer-based crystal modifiers. In some embodiments, methods comprising the use of one or more crystal modifiers, e.g., one or more polymer-based crystal modifiers, may be used to treat, reduce, control, prevent, and/or inhibit the formation of halite in desalinization processes, and any of the technologies, processes, and/or apparatuses involved with the application of thermal energy to distill water, vapor compression distillation, reverse osmosis, freeze-thaw, and/or electrodialysis.

As used herein, the terms “treatment of halite”, “treating halite”, “preventing halite”, “controlling halite”, and “inhibiting halite”, the like, generally refer to using crystal modifiers and/or compositions comprising crystal modifiers, such as those described herein, to treat, reduce, control, prevent, and/or inhibit the amount of halite formed and/or treat, reduce, control, prevent, and/or inhibit the rate of formation of halite in various industrial processes and systems in which halite may form, and/or reduce the amount of water required for halite removal or prevention as compared to in equivalent processes that do not contain the crystal modifiers and/or compositions comprising.

As used herein, the term “fluid in need of treatment” generally refers to any fluid which may comprise halite and/or in which halite may form and/or in which sodium and chloride may precipitate as halite. In some embodiments, a fluid in need of treatment may comprise produced water. In some embodiments, a fluid in need of treatment may comprise water related to gas production and/or gas exploration processes. In some embodiments, a fluid in need of treatment may comprise sea water or other brackish water that desirably is to be desalinated.

### Methods and Compositions

Disclosed herein are methods and compositions for the treatment or prevention of halite, such as halite resulting from any process related to oil or gas production, extraction, and/or recovery; as well as any industrial process in which halite formation is problematic to said process or to the functioning, stability and/or physical integrity of materials such as apparatus used in such processes. Further disclosed herein are environments such as oil and gas wells and other environments wherein halite formation is problematic which are treated with an amount of one or more crystal modifiers effective to reduce halite formation or deposition. In some embodiments, a method for treating or preventing halite may comprise treatment with one or more crystal modifiers. In some embodiments, a method for treating or preventing halite may comprise treatment with one or more polymer-based crystal modifiers. In some embodiments, a method for treating or preventing halite may comprise treatment with a copolymer of sulfonated monomers and carboxylic acid monomers, wherein said copolymer may be amine-neutralized. In some embodiments, said copolymer of sulfonated monomers and carboxylic acid monomers which may be amine-neutralized may comprise one or more of the following: vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate. In some embodiments, said copolymer of sulfonated monomers and carboxylic acid monomers which may be amine-neutralized may comprise one or more of the following: acrylic acid, methacrylic acid, crotonic acid, itaconic acid, fumaric acid, and/or maleic acid. In some embodiments, said copolymer of sulfonated monomers and carboxylic acid monomers which may be amine neutralized may comprise any one or more of the following amine moieties: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine. In some embodiments, said copolymer of sulfonated monomers and carboxylic acid monomers which may be amine neutralized may comprise any one or more of the following amine moieties: mono-, di-, and tri-ethanolamine. In some embodiments, said copolymer of sulfonated monomers and carboxylic acid monomers which may be amine neutralized may comprise any one or more of the following amine moieties: N,N-dimethylethanolamine (DMEA), N-methyldiethanolamine (MDEA), and/or N-methylethanolamine (NMEA). In some embodiments, said copolymer of sulfonated monomers and carboxylic acid monomers which may be amine neutralized may comprise aminoethylethanolamine. In some embodiments, said copolymer of sulfonated monomers and carboxylic acid monomers which may be amine neutralized may comprise N-methyldiethanolamine. In some embodiments, said copolymer of sulfonated monomers and carboxylic acid monomers which may be amine neutralized may comprise N-methylethanolamine. Moreover, in some embodiments, a copolymer of sulfonated monomers and carboxylic acid monomers which may be amine neutralized and which may be used to treat halite may comprise one or more ethylenically unsaturated diacid components which may comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride. In general, the ethylenically unsaturated dicarboxylic acids and anhydrides may comprise 4 to 8 carbon atoms, however, in some embodiments, they may comprise anywhere from 4 to 36 carbon atoms. In some embodiments, a method for treating or preventing halite may comprise treatment with one or more polymer-based crystal modifiers, wherein said one or more polymer-based crystal modifiers comprise an ethanolamine salt of a copolymer of sodium allyl sulphonate and maleic anhydride.

In some embodiments, a method for treating or preventing halite may comprise treatment with a synergistic combination of one or more polymer-based crystal modifiers, wherein at least one of said one or more crystal modifiers comprise an ethanolamine salt of a copolymer of sodium allyl sulphonate and maleic anhydride, and one or more ferrocyanide-based crystal modifiers, e.g., a salt form of [Fe(CN)₆]⁴⁻. In some embodiments, methods of treating halite with one or more crystal modifiers may prevent or inhibit formation of halite, e.g., may prevent or inhibit halite formation in a fluid in need of treatment, such as produced water which may have resulted from an oil or gas production or recovery process. In some embodiments, methods of treating halite with one or more crystal modifiers, e.g., one or more polymer-based crystal modifiers, e.g., a synergistic combination of one or more polymer based crystal modifiers and one or more ferrocyanide salt-based crystal modifiers, may result in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of halite formation as compared to a method which did not comprise treatment with said one or more crystal modifiers. In some embodiments, methods of treating halite with one or more crystal modifiers may result in a decrease in the amount of water that is required to treat or prevent halite formation as compared to a method which did not comprise the use of said one or more crystal modifiers, such as, for example, eliminating the need to add any amount of water to treat halite as a result of treating said fluid with one or more polymer-based crystal modifiers. For example, methods of treating halite with one or more crystal modifiers may result in a reduction in the amount of water that is required to treat or prevent halite formation by about 1% or less, 1% or more, 5% or more, 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, 90% or more, 91% or more, 92% or more, 93% or more, 94% or more, 95% or more, 96% or more, 97% or more, 98% or more, 99% or more, or 100%, as compared to a method which did not comprise the use of said one or more crystal modifiers.

In some embodiments, methods of treating or preventing halite may comprise treatment with one or more crystal modifiers, such as one or more polymer-based crystal modifiers, or treatment with a synergistic combination of one or more polymer-based crystal modifiers and one or more ferrocyanide salt-based crystal modifiers, wherein the efficacy of such treatments may be measured by observing the percent transmittance of a solution in which halite formation may occur, such as the methods described in the present examples. For example, by practicing the methods of treatment described herein, the percent transmittance of such a solution wherein halite may form may decrease by 0.5% or less, 1.0% or less, 2.0% or less, 3.0% or less, 4.0% or less, 5.0% or less, 6.0% or less, 7.0% or less, 8.0% or less, 9.0% or less, 10.0% or less, 12.5% or less, 15.0% or less, 17.5% or less, 20% or less, 25% or less, 30% or less, 35% or less, 40% or less, 45% or less, 50% or less, 55% or less, 60% or less, or 60% or more as compared to its initial value.

In some embodiments, methods of treating or preventing halite with one or more crystal modifiers, e.g., one or more polymer-based crystal modifiers, may comprise adding 5 ppm or less, 10 ppm or less, 15 ppm or less, 20 ppm or less, 40 ppm or less, 60 ppm or less, 80 ppm or less, 100 ppm or less, 120 ppm or less, 140 ppm or less, 150 ppm or less, or 150 ppm or more of said one or more crystal modifiers. In some embodiments, methods of treating or preventing halite with a synergistic combination of one or more polymer-based crystal modifiers and one or more ferrocyanide salt-based crystal modifiers may comprise adding 5 ppm or less, 10 ppm or less, 15 ppm or less, 20 ppm or less, 40 ppm or less, 60 ppm or less, 80 ppm or less, 100 ppm or less, 120 ppm or less, 140 ppm or less, 150 ppm or less, or 150 ppm or more of each of said one or more polymer-based crystal modifiers and said one or more ferrocyanide salt-based crystal modifiers.

In some embodiments, one or more crystal modifiers for use in the treatment or preventing of halite may be provided in liquid form, e.g., as an aqueous solution. In some embodiments, one or more crystal modifiers for use in the treatment of halite may be water-soluble. In some embodiments, one or more crystal modifiers for use in the treatment of halite may be provided in dry form and/or powder form. In some embodiments, methods of treating halite with one or more crystal modifiers may comprise treatment with one or more crystal modifiers, e.g., an ethanolamine salt of a copolymer of sodium allyl sulphonate and maleic anhydride, whose molecular weight may be from about 1800 to about 2300 Daltons, e.g., 1800, 1850, 1900, 1950, 2000, 2050, 2100, 2150, 2200, 2250 or 2300 Daltons±10%. In some embodiments, said molecular weight may be about 1800 Daltons or less, or about 1800 Daltons or more. In some embodiments, said molecular weight may be about 2300 Daltons or less, or about 2300 Daltons or more.

In some embodiments, addition and/or introduction of one or more crystal modifiers in a method for treatment or prevention of halite may be a continuous application or a direct, e.g., intermittent injection of said one or more crystal modifiers into the process and/or component in need of treatment, e.g., continuous or direct injection into a formation in need of treatment. Said application and/or injection may be accomplished using any techniques known and used in the art, especially methods used in oil and gas recovery and treatment of oil and gas deposits and desalination methods. In some embodiments, addition and/or introduction of said one or more crystal modifiers may be intermittent addition to the fluid as necessary or desired. In some embodiments, the amount of one or more crystal modifiers used to treat halite may be any amount that results in a desired effect, i.e., any desired degree of reduction of halite formation or reduction in the rate of halite formation inhibition, reduction, prevention, and/or control that is desired for a given process.

In some embodiments, methods of treating or preventing halite with one or more crystal modifiers may occur at any temperature at which a process in need of treatment of halite occurs. For example, the temperature may be atmospheric temperature. In some instances, the temperature may be 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, 100° C. or more, 125° C. or more, or 150° C. or more. In some embodiments, a crystal modifier, such as a polymer-based crystal modifier, that is thermally treated may demonstrate a similar performance or the same performance or better performance as the same crystal modifier that has not be thermally treated. For example, a thermal treatment may be treatment of said crystal modifier at an elevated temperature for a duration of time, such as, for example, treatment at 150° C. or less or 150° C. or more for 3 days or less or 3 days or more.

In some embodiments, methods of treating or preventing halite with one or more crystal modifiers may occur at any pH at which a process in need of treatment of halite occurs.

In some embodiments, one or more crystal modifiers, e.g., one or more polymer-based crystal modifiers, such as a copolymer of sulfonated monomers and carboxylic acid monomers, wherein said copolymer may be amine-neutralized, e.g., an ethanolamine salt of a copolymer of sodium allyl sulphonate and maleic anhydride, may be biodegradable. The biodegradability of said one or more crystal modifiers may be measured in accordance with any of the standard test methods for biodegradability: OECD Guidelines for Testing of Chemicals, 1992, 306, or any of the four protocols (known to those skilled in the art as “Marine BODIS Test,” “OECD Guideline 306 Closed Bottle Test,” “Marine CO₂ Headspace Biodegradation Test,” and “Marine CO₂ Evolution Test”) described in the report “Biodegradability of chemicals in sea water. Results of a ring tests undertaken by OSPARCOM, reported by Elf Akvamiljo, September 1996.” It has been determined that each of these test methods gives comparable results. In the event that the test methods are found to give significantly different results, the Marine BODIS test is to be used to determine the biodegradability of the one or more crystal modifiers described herein. Results regarding the biodegradability of such polymer-based crystal modifiers as those discussed herein, e.g., a crystal modifier comprising a copolymer of sulfonated monomers and carboxylic acid monomers, wherein said copolymer may be amine-neutralized , e.g., a crystal modifier comprising an ethanolamine salt of a copolymer of sodium allyl sulphonate and maleic anhydride, may be found, for example, in WO/2007/075603, which is incorporated by reference in its entirety. In some embodiments, the biodegradability of said one or more crystal modifiers may allow for the fluid treated with said one or more crystal modifiers to be reused in any desired process and/or discharged into the environment.

The one or more crystal modifiers described herein may be used in methods for the treatment or prevention of halite in aqueous systems. In some embodiments, a method for treating halite, may comprise adding one or more crystal modifiers as described herein to an aqueous system in need of halite treatment, in an amount effective to reduce or inhibit halite in the aqueous system. Methods for identifying aqueous systems in need of halite treatment are known to those skilled in the art.

A broad variety of aqueous systems may be treated to reduce halite using the methods described herein. Non-limiting examples of such aqueous systems include boiler water, cooling water, water at various stages of desalination processes, seawater (e.g., in oil platform applications), brackish water, oilfield water (e.g., topside and/or downhole), coal processing water, and industrial treatment plant water. The amount of one or more crystal modifiers that is effective to reduce or inhibit scale in a particular aqueous system may be determined by routine experimentation in light of the guidance provided herein. In some embodiments, a method for treating or preventing halite may comprise adding one or more crystal modifiers to oilfield water in need of halite treatment, in an amount effective to reduce or inhibit halite in the oilfield water. For example, the crystal modifier may be added to process water (produced water) on an oil platform. The oilfield water may be downhole water that is pumped underground (e.g., for enhanced oil recovery) and/or may be used to treat topside oilfield water. In some embodiments, methods of treating halite with one or more crystal modifiers may comprise treatment of water that is used in and/or results from any part of an enhanced oil recovery process. In some embodiments, methods of treating or preventing halite with one or more crystal modifiers may comprise treatment of water that is used in and/or results from any part of a gas recovery or production process. In some embodiments, methods of treating or preventing halite with one or more crystal modifiers may comprise treatment of water that is used in and/or results from any part of a mining process. In some embodiments, methods of treating or preventing halite with one or more crystal modifiers may comprise treatment of produced water. In some embodiments, methods of treating or preventing halite with one or more crystal modifiers may comprise treating a formation in which halite may form. In some embodiments, methods of treating or preventing halite with one or more crystal modifiers may comprise treatment of a fluid in need of treatment, such as any fluid in which halite may form, particularly wherein halite formation is problematic for a process in which the fluid in need of treatment may be used or may be a part of.

In some embodiments, methods of treating or preventing halite with one or more crystal modifiers may be used in conjunction with one or more processes involved with low cut gas wells. For example, in such wells, after brine comes to saturation, halite may begin to precipitate and plug production lines, filters, pumps, and/or screens, for example, and treatment with one or more crystal modifiers may reduce the occurrence or severity of, prevent, and/or eliminate such events from occurring. Furthermore, methods of treating or preventing halite with one or more crystal modifiers may be used in conjunction with any process that may involve formation of brine in which halite may form and may plug production lines, filters, pumps, and/or screens. In some embodiments, methods of treating or preventing halite with one or more crystal modifiers may prevent and/or reduce plugging of a fluid conduit disposed in an injection wellbore. In some embodiments, methods of treating or preventing halite with one or more crystal modifiers may prevent and/or reduce plugging of a subterranean formation. In some embodiments, methods of treating or preventing halite with one or more crystal modifiers may prevent and/or reduce plugging of a production well and/or components associated with a production well.

In some embodiments, methods comprising the use of one or more crystal modifiers, e.g., one or more polymer-based crystal modifiers, may be used to treat, reduce, control, prevent, and/or inhibit the formation of halite in desalinization processes, such as any of the technologies, processes, and/or apparatuses involved with application of thermal energy to distill water, vapor compression distillation, reverse osmosis, freeze-thaw, and/or electrodialysis. With regard to such desalination processes and desalination processes in general, a typical limiting factor for water revery may generally be the solubility of the concentrated salts, such as sodium chloride (halite). As such, in some embodiments, treatment of water involved with any one or more desalination processes with one or more crystal modifiers may increase the amount of water recovered and/or may allow for transport of a high concentration of brine without precipitation of halite as a result of said treatment with one or more crystal modifiers.

Furthermore, in some embodiments, methods of treating or preventing halite with one or more crystal modifiers may comprise addition of said one or more crystal modifiers to a circulating fluid. In some embodiments, the circulating fluid is utilized in, or is a component of, a mining process, or is in a system that is utilized in a mining process. In some embodiments, the circulating fluid is utilized in, or is a component of, an oil and gas exploration or production process, or is in a system that is utilized in an oil and gas exploration and production process. In some embodiments, the circulating fluid is utilized in, or is a component of, coal processing, or is in a system that is utilized in coal processing (e.g., coal slurry transport). In some embodiments, the circulating fluid is utilized in, or is a component of, a desalination process.

Moreover, the present disclosure generally relates to a composition suitable for use in the treatment of halite, comprising one or more crystal modifiers and a fluid in need of treatment, i.e., a fluid in which halite may form, such as, for example, produced water resulting from any of the industrial processes described herein or known in the art. In some embodiments, a composition suitable for use in the treatment of halite may comprise a copolymer of sulfonated monomers and carboxylic acid monomers, wherein said copolymer may be amine-neutralized. In some embodiments, said copolymer of sulfonated monomers and carboxylic acid monomers which may be amine-neutralized may comprise one or more of the following: vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate. In some embodiments, said copolymer of sulfonated monomers and carboxylic acid monomers which may be amine-neutralized may comprise one or more of the following: acrylic acid, methacrylic acid, crotonic acid, itaconic acid, fumaric acid, and/or maleic acid. In some embodiments, said copolymer of sulfonated monomers and carboxylic acid monomers which may be amine neutralized may comprise any one or more of the following amine moieties: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine. In some embodiments, said copolymer of sulfonated monomers and carboxylic acid monomers which may be amine neutralized may comprise any one or more of the following amine moieties: mono-, di-, and tri-ethanolamine. In some embodiments, said copolymer of sulfonated monomers and carboxylic acid monomers which may be amine neutralized may comprise any one or more of the following amine moieties: N,N-dimethylethanolamine (DMEA), N-methyldiethanolamine (MDEA), and/or N-methylethanolamine (NMEA). In some embodiments, said copolymer of sulfonated monomers and carboxylic acid monomers which may be amine neutralized may comprise aminoethylethanolamine. In some embodiments, said copolymer of sulfonated monomers and carboxylic acid monomers which may be amine neutralized may comprise N-methyldiethanolamine. In some embodiments, said copolymer of sulfonated monomers and carboxylic acid monomers which may be amine neutralized may comprise N-methylethanolamine. Moreover, in some embodiments, a composition suitable for use in the treatment of halite may comprise a copolymer of sulfonated monomers and carboxylic acid monomers which may be amine neutralized, which may comprise one or more ethylenically unsaturated diacid components which may comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride. In general, the ethylenically unsaturated dicarboxylic acids and anhydrides may comprise 4 to 8 carbon atoms, however, in some embodiments, they may comprise anywhere from 4 to 36 carbon atoms. In some embodiments, a composition suitable for use in the treatment of halite may comprise an ethanolamine salt of a copolymer of sodium allyl sulphonate and maleic anhydride. In some embodiments, a composition suitable for use in the treatment of halite may comprise one or more polymer-based crystal modifiers and one or more ferrocyanide salt-based crystal modifiers. In some embodiments, In some embodiments, a composition suitable for use in the treatment of halite may comprise one or more polymer-based crystal modifiers that comprise an ethanolamine salt of a copolymer of sodium allyl sulphonate and maleic anhydride and one or more ferrocyanide salt-based crystal modifiers. Such a composition may produce synergistic results when used in methods of treating halite, such as those methods described herein.

In some embodiments, said fluid in need of treatment may comprise a circulating fluid, such as, but not limited to, a circulating fluid utilized in, or is a component of, a mining process, or is in a system that is utilized in a mining process; a circulating fluid is utilized in, or is a component of, an oil and gas exploration or production process, or is in a system that is utilized in an oil and gas exploration and production process; a circulating fluid is utilized in, or is a component of, a desalination; or a circulating fluid is utilized in, or is a component of, coal processing, or is in a system that is utilized in coal processing (e.g., coal slurry transport). In some embodiments, said fluid in need of treatment may comprise fluid used in any process or part of a process involved in such process as, but not limited to, a mining process, or a system that is utilized in a mining process; an oil and gas exploration or production process, or an oil and gas exploration and production process; a desalination process, or a system that is utilized in a desalination process; or coal processing, or is in a system that is utilized in coal processing (e.g., coal slurry transport). In some embodiments, a fluid in need of treatment may comprise produced water. In some embodiments, a fluid in need of treatment may comprise a fluid in which halite may form, particularly wherein halite formation is problematic for a process in which the fluid in need of treatment may be used or may be a part of. In some embodiments, said fluid in need of treatment may comprise sodium and chloride that precipitate as halite. In some embodiments, said fluid in need of treatment comprises boiler water, cooling water, seawater (e.g., in oil platform applications), brackish water, water at various stages of desalination processes, oilfield water (e.g., topside and/or downhole), coal processing water, or industrial treatment plant water. In some embodiments, said fluid in need of treatment may comprise oilfield water in need of treatment, i.e., in which halite may foiru. In some embodiments, said fluid in need of treatment may comprise downhole water that is pumped underground (e.g., for enhanced oil recovery). In some embodiments, said fluid in need of treatment may comprise topside oilfield water. In some embodiments, said fluid in need of treatment may comprise any fluid resulting from any part of a process associated with enhanced oil recovery. In some embodiments, said fluid in need of treatment may comprise produced water. In some embodiments, said fluid in need of treatment may comprise water that is used in and/or results from any part of a gas recovery process. In some embodiments, said fluid in need of treatment may comprise water that is used in and/or results from any part of a process associated with a low cut gas well. In some embodiments, said fluid in need of treatment may comprise water that is used in and/or results from any part of a mining process. In some embodiments, said fluid in need of treatment may comprise sea water or another water that is being desalinated.

### EXAMPLES

### Example 1: Treatment of Halite

In this example, a solution in which halite crystals were able to form was prepared, and both a control experiment in which no polymer-based crystal-modifier was added and experiments which evaluated the performance of various different doses of a polymer-based crystal modifier, which comprised an ethanolamine salt of a copolymer of sodium allyl sulphonate and maleic anhydride, were performed.

First, solutions of sodium chloride and calcium chloride were prepared. A 6.11 molal solution of sodium chloride was prepared by adding 37 g of NaCl to 1 kg of DI water and dissolving the sodium chloride with stirring. It should be noted that a trace amount of undissolved crystals may have remained while the solution was kept at room temperature, as solubility of NaCl can be affected by temperature. A 6.7 molal solution of calcium chloride was prepared by adding 98.5 g of CaCl₂-2H₂O to 100 g of DI water and dissolving the CaCl₂-2H2O with stirring.

A schematic of the halite testing system used in the present example is presented in FIG. 1. The protocol for both the control experiment, in which no polymer based crystal modifier was added, and experiments in which various different doses of a polymer-based crystal modifier were added , was as follows. First, an oven and vial heating sleeve (aluminum-based), both of which were used to maintain target temperatures for testing, were turned on and set to the target temperature. Next, a Brinkman Probe Colorimeter, which was used to measure the percent transmittance of the solutions tested, was turned on, and a ColeParmer SpinCadet Model 4650-50 magnetic stirrer was set at setting 4. Once the oven had reached the target temperature set point, pumping of the NaCl solution was initiated and was flowed for 6 minutes, with all outflow directed into waste. This step was used to flush the NaCl column and lines with approximately one dead-volume's worth of saturated NaCl solution. While the NaCl flush was being performed, a 3 mL syringe was filled to about the 3.0 mL mark with the 6.7 molal CaCl₂ using a 10 mL syringe connected to a 3 mL syringe through a 3-way valve. Additionally, a ½″ long triangular stir bar was added to a 35 mL glass vial, and the vial was marked at the 20 mL fill line using a measuring sleeve. Afterward, the vial was placed in the aluminum heating sleeve until it was brought to the target temperature. To initiate a control or experimental run, the 3 way NaCl valve was turned to the delivery position, and the delivery line was filled with fresh solution. Next, the reaction vial was mounted onto the stationary cap that held the optical probe and the solution delivery tubes. The 3-way NaCl valve was then turned to allow for delivery of solution to the reaction vial and to fill the vial to the 20 mL mark with the solution. During the filling, the transmittance value was observed and was set to 100% by pressing the “zero” button. Furthermore, the transmittance was monitored for a few minutes to ensure that the value set to be 100% was stable, and, if necessary, “zero” was pressed again once a stable transmittance value was achieved. After the stable value was reached and maintained, the data logger (WinDaq program) was opened and prepared for data collection. Next, the syringe pump was started at setting 99 to begin delivery of the CaCl₂ solution, and at the same time, the data logging was started. Additionally, a stopwatch was used to time the procedure. The CaCl₂ solution was delivered until such time that the target volume was delivered, which amount varied with temperature. For example, at 30° C., a period of 50 seconds delivered about 180 μL of CaCl₂ solution and created appropriate halite conditions. At 90° C., an injection period of about 9 minutes (about 2.0 mL) gave the appropriate halite conditions. During this time period, and after, the percent transmittance was monitored, and the percent transmittance began to decrease upon halite formation. Monitoring continued until the percent transmittance measured stabilized, at which time the data logging was stopped and the experiment was ended.

In the instance of the control experiment presented in FIG. 1, the above protocol was used, in which, for Test 1 of FIG. 1, 1.69 mL of the CaCl₂ solution was added (7 minutes of pumping at pump setting 9.9), and for Test 2 of FIG. 1, 1.56 mL of the CaCl₂ solution was added (7.5 minutes at pump setting 9.9). For both Test 1 and Test 2 of FIG. 1, the temperature was maintained at 91.3° C.

Referring to FIG. 2, various different amounts of a polymer-based crystal modifier, which comprised an ethanolamine salt of a copolymer of sodium allyl sulphonate and maleic anhydride, were evaluated for their effects on halite formation in separate experimental runs. Experimental runs which used 20, 40, 60, 80, and 100 ppm of said crystal modifier (“A”, “B”, “C”, “D”, and “E” of FIG. 2, respectively) were performed and evaluated, and two blank runs, in which no crystal modifier was present (“F” and “G” of FIG. 2), were perfoimed and evaluated. The protocol described above was used, with the modification that the crystal modifier was added to the test vial prior to the addition of the CaCl₂. During this set of experiments, the temperature was maintained at 60° C.

The data of FIG. 2 demonstrated that the polymer-based crystal modifier was able to inhibit halite crystal formation at various different dosages. It was observed that the maximum inhibition of halite formation occurred at a dosage of 100 ppm of the polymer-based crystal modifier as the percent transmittance decreased by approximately less than 5% as compared to its initial value.

Referring to FIG. 3, two different doses of a polymer-based crystal modifier, which comprised an ethanolamine salt of a copolymer of sodium allyl sulphonate and maleic anhydride, were evaluated for their effects on halite formation wherein the temperature of the experimental runs was 60° C. Experimental runs using either 75 or 100 ppm of said crystal modifier were performed and evaluated, and one control run (“blank”), in which no crystal modifier was present, was performed and evaluated. The protocol described above with regard to FIG. 2 was used, with the modification that the temperature was maintained at 60° C., and only two different doses, 75 and 100 ppm, of crystal modifier were used.

The data of FIG. 3 demonstrated that the crystal modifier was able to inhibit crystal formation at 60° C. It was observed that the maximum inhibition of halite formation occurred at a dosage of 100 ppm of the crystal modifier as the percent transmittance decreased by approximately less than 10% as compared to its initial value.

### Example 2: Comparative Treatment of Halite

In this example, a solution in which halite crystals were able to form was prepared as described above in Example 1, and the performance of a ferrocyanide-based crystal modifier, which comprises [Fe(CN)₆]⁴⁻, and a polymer-based crystal modifier, which comprised an ethanolamine salt of a copolymer of sodium allyl sulphonate and maleic anhydride, were evaluated at various doses.

The procedure for performing the tests of Example 2 were the same as for those of Example 1, with the exception that experimental runs were performed using either 10 ppm (“A” of FIG. 4) or 20 ppm (“B” of FIG. 4) of the ferrocyanide-based crystal modifier, or either 10 (“C” of FIG. 4) ppm or 20 ppm (“D” of FIG. 4) of the polymer-based crystal modifier. A control (blank) run (“E” of FIG. 4) was performed as well. The temperature was maintained at 60° C. for all of the runs.

Referring now to FIG. 4, the data of FIG. 4 demonstrated that the polymer-based crystal modifier and the ferrocyanide-based crystal modifier were able to inhibit halite formation. For example, a dosage of 20 ppm of the polymer-based crystal modifier was able to inhibit halite formation, as evidenced by only an approximately 20% decrease in transmittance of the sample as compared to its initial value.

### Example 3: Synergetic Treatment of Halite

In the present example, a solution in which halite crystals were able to form was prepared as described above in Example 1, and the effects of treating halite with a combination of a ferrocyanide salt and a polymer-based crystal modifier, which comprised an ethanolamine salt of a copolymer of sodium allyl sulphonate and maleic anhydride, were evaluated.

The procedure for performing the trial runs of Example 3 were the same as for those of Example 1, with the exception that trial runs were performed using either 10 ppm of the ferrocyanide salt-based crystal modifier (“A” of FIG. 5); 10 ppm of the polymer-based crystal modifier (“B” of FIG. 5); or a combination of 5 ppm of the ferrocyanide-based crystal modifier and 5 ppm of the polymer-based crystal modifier (“C” of FIG. 5). A control (blank) run (“D” of FIG. 5) was performed as well. The temperature was maintained at 60° C. for all of the trial and control runs.

Referring now to FIG. 5, the data of FIG. 5 demonstrated the synergistic effect of using a combination of the ferrocyanide salt-based crystal modifier and the polymer-based crystal modifier. For example, a 10 ppm dose of the ferrocyanide salt-based crystal modifier resulted in a decrease of approximately 30% of transmittance, and a 10 ppm dose of the polymer-based crystal modifier resulted in a decrease of approximately 35% of transmittance as compared to their respective initial values. However, when using 5 ppm of the polymer-based crystal modifier in combination with 5 ppm of the ferrocyanide salt-based crystal modifier (a 10 ppm total dose), the transmittance decreased by approximately less than 10% as compared to its initial value, thereby demonstrating a synergistic effect of treatment of halite with the combination of crystal modifiers.

### Example 4: Thermal Stability of a Crystal Modifier used for Halite Treatment

In this example, a solution in which halite crystals were able to form was prepared as described above in Example 1, and the performance of a polymer-based crystal modifier, which comprised an ethanolamine salt of a copolymer of sodium allyl sulphonate and maleic anhydride at various different dosages were compared before and after a 150° C. thermal treatment of said polymer-based crystal modifier.

The procedure for performing the trial runs of Example 4 were the same as for those of Example 1, with the exception that trial runs were performed using either a non-thermal treated dose of polymer-based crystal modifier or a thermal treated dose of polymer-based crystal modifier, where dosages of 20, 50, and 100 ppm of untreated polymer-based crystal modifier (“A”, “B”, and “C” of FIG. 6, respectively) and 20, 50, and 100 ppm of treated polymer-based crystal modifier (“D”, “E”, and “F” of FIG. 6, respectively) were compared. A control (blank) run (“G” of FIG. 6) was performed as well. For the treated sample of polymer-based crystal modifier, three different solutions, each comprising one of the different doses, was heated at 150° C. for three days, and then the thermal-treated solutions were used for the trial runs, which were performed at 60° C.

Referring now to FIG. 6, the data of FIG. 6 demonstrated thermally treated versions of the polymer-based crystal modifier, which comprised an ethanolamine salt of a copolymer of sodium allyl sulphonate and maleic anhydride, and an untreated versions of the polymer-based crystal modifier, were both able to inhibit halite formation. For example, at a 100 ppm dosage, both the thermally treated and untreated polymer-based crystal modifier demonstrated approximately a less than 25% decrease in transmittance of the test solution as compared to its initial value. Notably, the thermally treated polymer-based crystal modifier demonstrated only approximately less than a 15% decrease in transmittance as compared to its initial value.

In the preceding procedures, various steps have been described. It will, however, be evident that various modifications and changes may be made thereto, and additional procedures may be implemented, without departing from the broader scope of the procedures as set forth in the claims that follow.

1. A method for treating halite, wherein said method comprises adding or introducing one or more crystal modifiers to a fluid in need of treatment.

2. The method of claim 1, wherein:
i. said one or more crystal modifiers comprise polymer-based crystal modifiers;
ii. said one or more crystal modifiers comprise a copolymer of sulfonated monomers and carboxylic acid monomers, wherein said copolymer is amine-neutralized;
said one or more crystal modifiers comprise one or more of the following:
vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate;
iv. said one or more crystal modifiers comprise one or more of the following: acrylic acid, methacrylic acid, crotonic acid, itaconic acid, fumaric acid, and/or maleic acid;
v. said one or more crystal modifiers comprise one or more of the following: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine;
vi. said one or more crystal modifiers comprise one or more of the following: mono-, di-, and tri-ethanolamine;
vii. said one or more crystal modifiers comprise one or more of the following: N,N-dimethylethanolamine (DMEA), N-methyldiethanolamine (MDEA), and/or N-methylethanolamine (NMEA);
viii. said one or more crystal modifiers comprise aminoethylethanolamine;
ix. said one or more crystal modifiers comprise N-methyldiethanolamine;
x. said one or more crystal modifiers comprise N-methylethanolamine;
xi. said one or more crystal modifiers comprise one or more ethylenically unsaturated diacid components which comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride;
xii. said one or more crystal modifiers comprise one or more polymer-based crystal modifiers comprising an ethanolamine salt of a copolymer of sodium allyl sulphonate and maleic anhydride;
xiii. said one or more crystal modifiers comprise one or more polymer-based crystal modifiers and one or more ferrocyanide salt-based crystal modifiers, optionally wherein said methods result in synergetic effects;
xiv. said one ormore crystal modifiers comprise one or more polymer-based crystal modifiers comprising an ethanolamine salt of a copolymer of sodium allyl sulphonate and maleic anhydride and one or more ferrocyanide salt-based crystal modifiers, optionally wherein said methods result in synergetic effects;
xv. said fluid in need of treatment comprises a fluid resulting from any part of processes related to oil or gas production, extraction, and/or recovery;
xvi. said fluid in need of treatment comprises a circulating fluid, optionally wherein said circulating fluid comprises any one or more of the following: a circulating fluid utilized in, or a component of, a mining process, or in a system that is utilized in a mining process; a circulating fluid utilized in, or a component of, an oil and gas exploration or production process, or in a system that is utilized in an oil and gas exploration and production process; a circulating fluid utilized in, or a component of, a desalination process; a circulating fluid utilized in, or a component of, coal processing, or in a system that is utilized in coal processing (e.g., coal slurry transport);
xvii. said fluid in need of treatment comprises produced water;
xviii. said fluid in need of treatment comprises sodium and chloride that precipitate as halite;
xix. treatment of said fluid with said one or more crystal modifiers results in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of halite formation as compared to a method which did not comprise the use of said one or more crystal modifiers;
xx. treatment of said fluid with said one or more crystal modifiers results in the percent transmittance of a fluid treated according to any of the foregoing methods decreasing by 0.5% or less, 1.0% or less, 2.0% or less, 3.0% or less, 4.0% or less, 5.0% or less, 6.0% or less, 7.0% or less, 8.0% or less, 9.0% or less, 10.0% or less, 12.5% or less, 15.0% or less, 17.5% or less, 20% or less, 25% or less, 30% or less, 35% or less, 40% or less, 45% or less, 50% or less, 55% or less, 60% or less, or 60% or more as compared to its initial value prior to treatment;
xxi. treatment of said fluid with said one or more crystal modifiers results in a decrease in the amount of water that is used to treat halite as compared to a method which does not comprise the use of said one or more crystal modifiers, optionally wherein the decrease in amount of water that is used to treat halite is elimination of the use of any amount of water to treat halite;
xxii. said method comprises adding or introducing 5 ppm or less, 10 ppm or less, 15 ppm or less, 20 ppm or less, 40 ppm or less, 60 ppm or less, 80 ppm or less, 100 ppm or less, 120 ppm or less, 140 ppm or less, 150 ppm or less, or 150 ppm or more of said one or more crystal modifiers;
xxiii. said methods comprises adding or introducing 5 ppm or less, 10 ppm or less, 15 ppm or less, 20 ppm or less, 40 ppm or less, 60 ppm or less, 80 ppm or less, 100 ppm or less, 120 ppm or less, 140 ppm or less, 150 ppm or less, or 150 ppm or more of each of one or more polymer-based crystal modifiers and one or more ferrocyanide salt-based crystal modifiers;
xxiv. said method comprises adding or introducing an amount of said one or more crystal modifiers which is an amount necessary to achieve a desired effect;
xxv. said method comprises adding or introducing an amount of one or more polymer-based crystal modifiers and one or more ferrocyanide salt-based crystal modifiers which are amounts necessary to achieve synergistic effects;
xxvi. said one or more crystal modifiers are provided in liquid form, such as an aqueous solution;
xxvii. said one or more crystal modifiers are provided in dry form and/or as a powder;
xxviii. said one or more crystal modifiers are water-soluble;
xxix. the molecular weight of said one or more crystal modifiers is between about 1800 to about 2300 Daltons;
xxx. said addition or introduction of one or more crystal modifiers is a continuous application;
xxxi. said addition or introduction of one or more crystal modifiers is a direct injection;
xxxii. treatment occurs at atmospheric temperature;
xxxiii. treatment occurs at 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, or 100° C. or more, 125° C. or more, or 150° C. or more;
xxxiv. thermal treatment of the one or more crystal modifiers does not affect the results achieved when using said one or more thermally treated crystal modifiers as compared to untreated versions of the one or more crystal modifiers;
xxxv. the pH at which treatment occurs is the pH of a fluid in need of treatment;
xxxvi. said one or more crystal modifiers are biodegradable;
xxxvii. said fluid comprises a fluid used in an aqueous system, optionally wherein said aqueous system is boiler water, cooling water, seawater (e.g., in oil platform applications), brackish water, oilfield water (e.g., topside and/or downhole), water at various stages of desalination processes, coal processing water, or industrial treatment plant water;
xxxviii. said fluid in need of treatment comprises oilfield water in need of treatment;
xxxix. said fluid in need of treatment comprises any fluid resulting from any part of a process associated with enhanced oil recovery;
xl. said fluid in need of treatment comprises water that is used in and/or results from any part of an gas recovery process;
xli. said fluid in need of treatment comprises water that is used in and/or results from any part of a process associated with a low cut gas well;
xlii. said fluid in need of treatment comprises water that is used in and/or results from any part of a mining process;
xliii. said fluid in need of treatment comprises water that is used in and/or results from and/or is a part of a desalination process, such as processes involved with application of thermal energy to distill water, vapor compression distillation, reverse osmosis, freeze-thaw, and/or electrodialysis;
xliv. treatment prevents and/or reduces the plugging of production lines, filters, pumps, and/or screens that are used in conjunction with said fluid in need of treatment;
xlv. treatment prevents and/or reduces plugging of a fluid conduit disposed in an injection wellbore;
xlvi. treatment prevents and/or reduces plugging of a subterranean formation; and/or
xlvii. treatment prevents and/or reduces plugging of a production well and/or components associated with a production well.

3. The method of claim 2, embodiment, xxxvi, wherein: wherein
i. fluid treated with said one or more crystal modifiers are reused in any desired process; and/or
ii. fluid treated with said one or more crystal modifiers are discharged into the environment.

4. The method of claim 2, embodiment xxxviii, wherein:
i. said oilfield water comprises downhole water that is pumped underground (e.g., for enhanced oil recovery); and/or
ii. said oilfield water comprises topside oilfield water.

5. A composition suitable for use in the treatment of halite, wherein said composition comprises one or more crystal modifiers and optionally a fluid in need of treatment.

6. The composition of claim 5, wherein:
i. said one or more crystal modifiers comprise one or more polymer-based crystal modifiers;
ii. said one or more crystal modifiers comprise a copolymer of sulfonated monomers and carboxylic acid monomers, wherein said copolymer is amine-neutralized;
iii. said one or more crystal modifiers comprise one or more of the following: vinyl sulfonic acid, acrylamide tertiary butyl sulfonic acid (also known as 2-acrylamido-2-methylpropane sulfonic acid or N-t-butyl acrylamide sulfonic acid) (“ATBS”), styrenesulfonic acid, sulfopropyl acrylate and/or sulfopropyl itaconate;
iv. said one or more crystal modifiers comprise one or more of the following: acrylic acid, methacrylic acid, crotonic acid, itaconic acid, fumaric acid, and/or maleic acid;
v. said one or more crystal modifiers comprise one or more of the following: methyl, dimethyl, trimethyl, ethyl, diethylamine, n-propyl, and di- and tri-propylamine; isopropyl, n-, sec-, tert-, and iso-butyl amine; and/or cyclohexyl, benzyl, and ethylenediamine;
vi. said one or more crystal modifiers comprise one or more of the following: mono-, di-, and tri-ethanolamine;
vii. said one or more crystal modifiers comprise one or more of the following: N,N-dimethylethanolamine (DMEA), N-methyldiethanolamine (MDEA), and/or N-methylethanolamine (NMEA);
viii. said one or more crystal modifiers comprise aminoethylethanolamine;
ix. said one or more crystal modifiers comprise N-methyldiethanolamine;
x. said one or more crystal modifiers comprise N-methylethanolamine;
xi. said one or more crystal modifiers comprise one or more ethylenically unsaturated diacid components which comprise in whole or in part one or more ethylenically unsaturated polycarboxylic acids, such as dicarboxylic acids or their anhydrides, including but not limited to fumaric acid, maleic acid, mesaconic acid, citraconic acid, muconic acid (e.g. trans-trans muconic acid) and itaconic acid, and any anhydrides thereof, such as maleic anhydride;
xii. said one or more crystal modifiers comprise one or more polymer-based crystal modifiers comprising an ethanolamine salt of a copolymer of sodium allyl sulphonate and maleic anhydride;
xiii. said one or more crystal modifiers comprise one or more polymer-based crystal modifiers and one or more ferrocyanide salt-based crystal modifiers;
xiv. said one or more crystal modifiers comprise one or more polymer based crystal modifiers comprising an ethanolamine salt of a copolymer of sodium allyl sulphonate and maleic anhydride and one or more ferrocyanide salt-based crystal modifiers;
xv. said fluid comprises a circulating fluid, optionally wherein said circulating fluid comprises a circulating fluid utilized in, or is a component of, a mining process, or is in a system that is utilized in a mining process; a circulating fluid is utilized in, or is a component of, an oil and gas exploration or production process, or is in a system that is utilized in an oil and gas exploration and production process; a circulating fluid utilized in, or a component of, a desalination process; or a circulating fluid is utilized in, or is a component of, coal processing, or is in a system that is utilized in coal processing (e.g., coal slurry transport);
xvi. said fluid comprises fluid used in any process or part of a process involved in such process as, but not limited to, a mining process, or a system that is utilized in a mining process; an oil and gas exploration or production process, or an oil and gas exploration and production process; a desalination process, or a system that is utilized in a desalination process; or coal processing, or is in a system that is utilized in coal processing (e.g., coal slurry transport);
xvii. said fluid comprises sodium and chloride that precipitate as halite;
xviii. said fluid in need of treatment comprises boiler water, cooling water, water at various stages of desalination processes, seawater (e.g., in oil platform applications), brackish water, oilfield water (e.g., topside and/or downhole), coal processing water, or industrial treatment plant water;
xix. wherein said fluid in need of treatment comprises oilfield water in need of treatment;
xx. said fluid in need of treatment comprises any fluid resulting from any part of a process associated with enhanced oil recovery;
xxi. said fluid in need of treatment comprises produced water;
xxii. said fluid in need of treatment comprises water that is used in and/or results from any part of an gas recovery process;
xxiii. said fluid in need of treatment comprises water that is used in and/or results from any part of a process associated with a low cut gas well;
xxiv. said fluid in need of treatment comprises water that is used in and/or results from any part of a mining process; and/or
xxv. said fluid in need of treatment comprises water that is used in and/or results from and/or is a part of a desalination process, such as processes involved with application of thermal energy to distill water, vapor compression distillation, reverse osmosis, freeze-thaw, and/or electrodialysis.

7. The composition of claim 6, embodiment xix, wherein:
i. said oilfield water comprises downhole water that is pumped underground (e.g., for enhanced oil recovery); and/or
ii. said oilfield water comprises topside oilfield water.
